(19) United States
(12) Patent Application Publication
(10) Pub. No.: US 2011/0053123 A1
(43) Pub. Date: Mar. 3, 2011

(54) METHOD FOR TEACHING LANGUAGE PRONUNCIATION AND SPELLING

(76) Inventor: Christopher John Lonsdale, Hong Kong (HK)

(21) Appl. No.: 12/832,350

(22) Filed: Jul. 8, 2010

Related U.S. Application Data
(60) Provisional application No. 61/275,438, filed on Aug. 31, 2009.

(51) Int. Cl. G09B 19/06

(52) U.S. Cl. 434/157

(57) ABSTRACT

The system is a comprehensive software application using audio-visual interactive multimedia components that aids users in learning how to effectively speak and write in a new language. The system combines simultaneous audio and video streams, an effective multimedia fusion to help language learners retain auditory and visual information. The system also applies an array of memory-retention techniques aiding the user to accurately comprehend spoken and written language information. The application uses memory-aid techniques such as, but not limited to, color-association, text (word, phrase, sentence) presentation, corresponding image association, humor-driven retention and rhythm. The whole system, therefore, is a powerful and exceptionally effective language teaching tool, a synthesis of sights, sounds and memory enhancing features, creating a rich and complete sensory learning experience.

### CROSS REFERENCE TO RELATED APPLICATIONS

This application claims the priority benefit of U.S. provisional application 61/275,438, “Audio-visual system for teaching correct pronunciation and spelling in a particular language and a method of the same for other languages”, inventor Christopher John Lonsdale, filed Aug. 31, 2009.

### BACKGROUND OF THE INVENTION

1. Field of the Invention

The invention relates to the field of communicative multimedia language education, particularly to the teaching of new languages.

2. Description of the Related Art

Advances in computers and multimedia technology have allowed the proliferation of new interactive teaching methods. These methodologies are useful for language teaching courses, because they allow students to learn at their own pace. Using multimedia techniques, audio clips, still images, or video materials can be incorporated to reinforce students' learning experience.

Interactive multimedia is the use of multiple types of media (audio, video, graphics, animation and text) within a single application or system. The complexity and scope of interactive multimedia depends upon the context in which the application is designed for. These systems can vary from small interactive programs designed to enhance learning of scope-specific concepts, to more complex stand-alone interactive software.

Although a number of different interactive multimedia systems, using a variety of methods and applications that aid students in learning new languages, have been proposed, learning a new language is still considered a very difficult process, particularly for adults. Thus, improved computerized language instruction methods are desirable.

### BRIEF SUMMARY OF THE INVENTION

Most prior art computerized language instruction methods are single-dimensional, using only audio or still images, and thus provide only limited learning impact. Furthermore, many of these techniques prior art techniques do not provide memory-retention features, and thus restraining the students' ability to retain the languages that they are studying. Further conventional language instruction methods, such as classroom settings, have a multitude of restrictions such as portability constraints, platform and technology limitations, and location dependencies.

The invention is based on the observation that initially, human beings learn their first or primary language through auditory and visual stimuli from their parents. As the parents and other adults around him converse in their native language, the human child “sees” the facial expressions they make and simultaneously “hears” the words they produce. Subconsciously, the child's neuro-system registers and absorbs all these different types of information, until one day the child starts to talk using the same language.

The invention teaches new languages by using a novel combination of sight and sound multimedia elements that have been interlaced with memory retention techniques. The invention allows users to learn a new language both in spoken and written form, while at the same time simultaneously stimulating multiple sensory perceptions that can lead to enhanced memory retention. Thus, the invention maximizes the learning potential of the user, allowing them to quickly learn and comprehend new languages.

The invention is specially designed for language teaching modules and providing a high-level of interactivity. The intelligent synthesis of multimedia and interactive elements accords the invention a high level of language-teaching capacity. This ultimately means that users can learn new languages more quickly and effectively, amplifying their ability to comprehend and retain learned knowledge of new languages.

The system utilizes simultaneous audio playback and video streams with the aim of teaching the user the correct pronunciation and spelling rules in a new language. The system produces the sound element of the pronunciation of the word being taught, which can be heard on headsets or speakers. The system also displays the word itself as text that can be read along with a visual element that is presented as a colored, animated text grapheme to help reinforce memorization. Videos of native speakers of languages are also used to show how the word is pronounced in the native tongue. The application also incorporates memory aid tools to help the user remember the language lessons. Memory retention techniques that the system utilizes include but are not be limited to, are color-, word-, and image-association, humor-driven retention, and rhythm. The combination of these various learning factors helps the user to comprehend and remember the words in the target language.

### BRIEF DESCRIPTION OF THE DRAWINGS

FIG. 1 shows a flow chart of the method of creating the language instructional multimedia materials.

FIG. 2 shows the invention installed on a portable media player

FIG. 3 shows the invention installed on a desktop computer

FIG. 4 shows the invention's graphical user interface

FIG. 5 shows a translation of a word in the user's native language

FIG. 6 shows the user interface displaying an animated grapheme of a word

FIG. 7 shows the invention's composite sequence of operation.

FIG. 8 shows a user or learner using the invention.

### DETAILED DESCRIPTION OF THE INVENTION

The system can be in the form of a software application that can be loaded onto digital devices, or digitally recorded onto a CD. These digital devices that the application can be installed include, but are not limited to, portable and non-portable devices. Portable devices that the system may be installed in include, but are not limited to, mobile phones, MP3 and MP4 players, gaming consoles, net books, tablet pc's and slates, and laptops. Non-portable devices that the system can be played back in include, but are not limited to, desktop computers, CD, VCD and DVD players and in-vehicle digital players. The device will usually have a visual output form, such as video screens, monitors or any visual display so that the user can see the images and videos played. The device shall also have audio output form through speaker systems, headsets or any other peripheral device that can produce audible sounds and other audio output.

In one embodiment, the invention may be a method of producing language instruction multimedia for instructing speakers of a first language on how to speak a target language. This method will generally comprise obtaining a list of the most frequently used words in a target language, and allocating individual words in this list to different sound groups. After this is done, lesson sized subgroups of words that each contains the same or similar sound group sounds are defined. Then for each word, cartoon images portraying the meaning of each word in these lesson sized subgroups are created. Ideally these cartoons will be chosen to be humorous or otherwise memorable. Also for each word, video and sound of a native speaker pronouncing each word in these lesson sized subgroups will be produced. Then for each lesson sized subgroup, three separate multimedia lessons will be produced. Here the first lesson may be a multimedia video of the image of the word and the video and sound of the word; the second lesson may comprises a multimedia video of the image of the word, the video and sound of the word, and the word presented in written form in the first language; and the third lesson may comprise a multimedia of the image of the word, the video and sound of the word, and the word presented in written form in the target language.

By combining various language teaching methods and memory-retention techniques, the invention reaches new levels of teaching efficiency. Some aspects and advantages of the invention include:
The system is an application that integrates audio and video interactive multimedia to maximize the learning experience.
The system plays a role-model video of a native speaker pronouncing each word correctly, allowing the user to more quickly adjust his or her own pronunciation technique.
The word's correct pronunciation appears as an interactive colored grapheme making its pronunciation easier to remember.
The word's corresponding written form in the target language is also displayed to reinforce the learning experience.
Computer animation of the key part of the grapheme in order to reinforce memory.
Colored sections of key parts of the grapheme help the user to closely follow the correct pronunciation of the word. This method has a double-edged purpose, as it also aids the user to visually remember the word's pronunciation.
The invention enhances pronunciation and writing skills by focusing the user's attention only on relevant information that pertains only to the current word being taught.
The invention relies on the natural human ability to connect a sound with the feeling in the throat and mouth in order to acquire correct pronunciation. The throat and mouth muscles are subconsciously trained to pronounce the words of a new language.
The system's application is fully functional and optimized for use on portable devices.
The application's digital nature means that a very large word database can be stored in a completely portable device.
The application is suitable for any learner from primary school right through to adulthood.
The invention eliminates the need for language teachers or the presence of another person to teach the new language to the user.
The invention can still be used in a standard, classroom setting, where students will simultaneously be able to take full advantage of the interactive application.
The invention can also be an internet-based application, allowing users to access the application anywhere through internet-capable devices.

Instructional materials according to the invention may generally be created by following the methods below:

The most general principles are that:

1. All of the sounds within a particular language must be covered
2. Those sounds are taught using high-frequency words

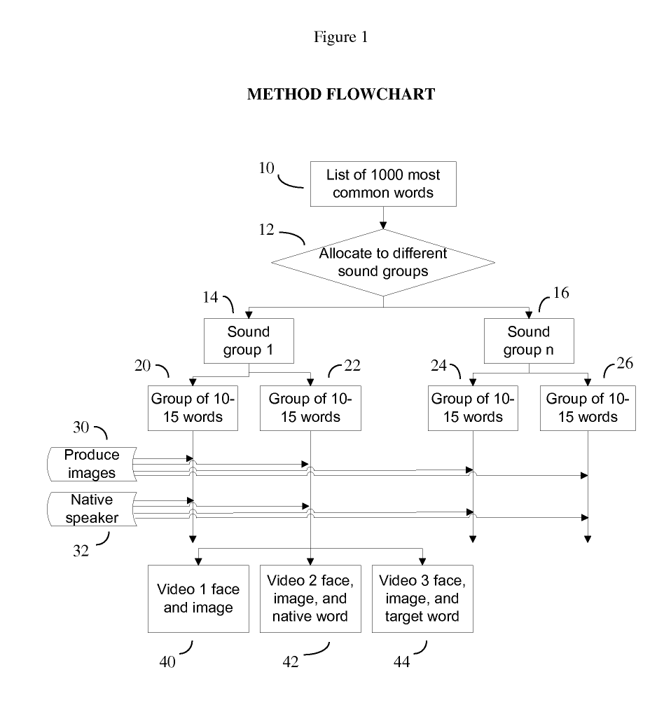

This method can transform a database of cartoons or images, frequent words in a native or target language, and a database of videos of native speakers speaking words in a native or target language into language instructional multimedia, suitable for running on a video player or computerized device. The method may implemented by either a human user operating upon this database using standard computer assisted audio, video, and graphical editing programs, or it may be implemented automatically or semi-automatically by a computer processor following the method and algorithm described below. This method is also illustrated in FIG. 1.

1. Obtain a list of approximately the 1,000 most commonly used words in a particular language. See FIG. 1 (10). Usually this list will be between about 500 and 2000 words, and more commonly between about 700 and 1300 words.
2. Allocate those words to different sound groups. (Each sound group forms the basis of a particular “lesson”). Typically a plurality of different sound groups such as _ sound groups will be obtained. See FIGS. 1 (12, 14 and 16). The number of sound groups and the sounds in the sound groups will vary between languages. For example, English has 44 sounds (and around 70 letter combinations for spelling them). Mandarin Chinese (formally known as “Putonghua”) has 58 unique sound groups. In general, most languages will have less than 100 sound groups.
3. Refine the allocation of words so that each lesson has, ideally, a similar number of words. Generally speaking, each “lesson” will contain between 8 and 20 words, and more commonly between about 10-15 words that all contain the particular sound that is being taught.
4. Summarize the content into a spreadsheet that includes the written form of each word in both native and target languages. Steps 3 and 4 are shown as FIGS. 1 (20 to 26).

Once this is done, then for each word:

1. Produce an image, such as a cartoon drawing, that communicates the meaning of each word. See FIG. 1 (30)
2. Record a native speaker pronouncing each word. The recording may be divided into “lessons”, just like the original content. See FIG. 1, (32).

These various components, (cartoons, video recordings, written words) are then combined into a finished product, wherein each lesson may includes three, separate videos. This is shown in FIGS. 1 (40), (42), and (44).

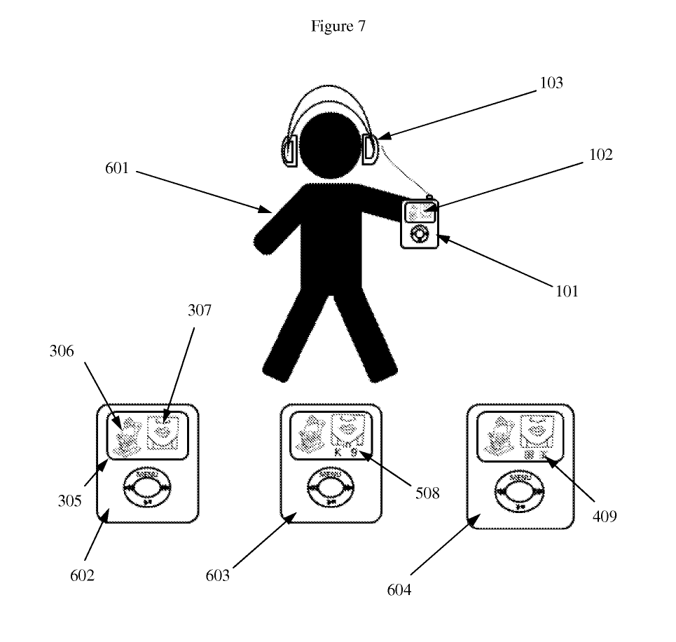

1. Video 1: In the first video, the learner can see only the native speaker's face and the cartoon drawing of each word. See FIG. 1 (40) and FIG. 7 (602).
2. Video 2: In the second video, the learner can see the native speaker's face, the cartoon drawing and the translation of each word, presented in their own native language. See FIG. 1 (42) and FIG. 7 (604) (here assuming that the native language is Mandarin).
3. Video 3: In the third and final video, the learner can see the native speaker's face, the cartoon drawing and the written form of each word, in the target language. See FIG. 1 (42) and FIG. 7 (603).

When preparing the videos, some other factors that are taken into consideration include:

1. The learner sees only the native speaker's face from the middle of the nose to the neck. The native speaker's eyes are deliberately removed from the video. The reason is that human nature is to look at someone's eyes when they are speaking. However, from the point of view of pronunciation training, it is more effective for the learner to focus exclusively on the movement of the native speaker's tongue, lips and cheeks.
2. There is a consistent time gap between each word in the video. The time gap must be long enough for the learner to repeat each word aloud, before the next word is pronounced. And, establishing a rhythm and tempo for the introduction of each new word also aids the memorization process.
3. The video that does NOT contain any subtitles (in either the target or native language) is the first one to be watched by the learner. The reason is that many learners have acquired bad pronunciation habits through poor instruction. Thus, upon seeing a particular letter combination in the target language, they will automatically recall an incorrect pronunciation. In order to “break” these bad habits, the learner must start by focusing purely on the way in which the native speaker manipulates their lips, tongue and cheek muscles, in order to produce a particular sound.
4. Later, when the written form of each word is presented in the target language, the key sound is highlighted. For example, if the sound being taught was “sh”, and the word was “ship”, then the “sh” part of the word would be highlighted in a different color and would appear to “jump” into the video. Deliberately drawing the learner's attention to the written representation of the sound helps to reinforce the spelling rules in the target language.

### Alternative Scenario 1

The invention's design and purpose need not be limited for personal use alone, but can also be used on a conventional classroom setting, wherein the application can be displayed onto widescreens, projectors, and the like. Language students can then simultaneously learn new languages, allowing them to benefit from the invention's wide range of advantages. It's noteworthy to point out that in this case, the system does not need the presence of a language teacher or coach. However, the system can still be used to complement any language teaching course existing today.

### Alternative Scenario 2

As another alternative scenario, the nature of the invention can also take the form of, but need not be limited to, an internet-based application that users can access anywhere. The application can then be run and used from any device connected to the internet. This scenario will mean that the invention will no longer need installation, but will instead be conveniently accessed by users from internet-capable devices.

The foregoing summary, as well as the following detailed description of the invention, will be better understood when read in conjunction with the appended drawings. For the purpose of illustrating the invention, there are shown in the drawings embodiments that are presently preferred. It should be understood, however, that the invention is not limited to the arrangement and instrumentalities shown.

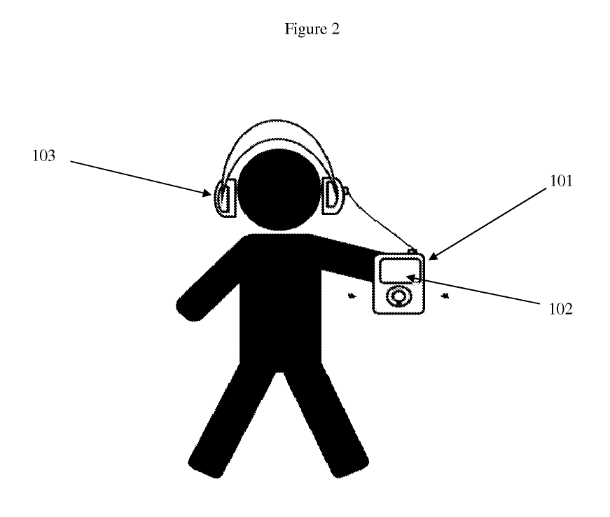

First Scenario—Referring to FIG. 2, the invention is shown as a software application installed or uploaded on a portable device player (101) such as an Apple iPod™. The device player (101) has a display screen that serves as a visual output sub-component (102) and fitted with a headset as the audio output sub-component (103) so the user can run the application. Digital device players (101) can be (but shall not be limited to) portable video players, mobile phones, net books, tablet PC's and slates, or laptop computers.

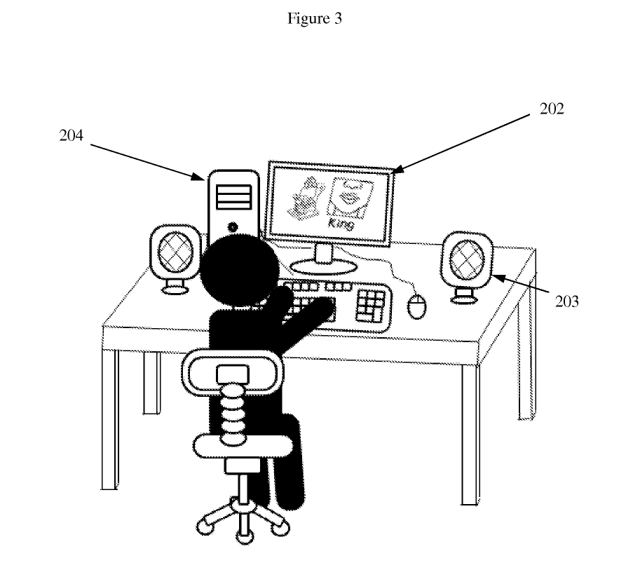

Second Scenario—An alternative scenario refers to FIG. 3 and shows the application installed or uploaded on a desktop computer (204). The computer (204) has a central processing unit, a display monitor to serve as the visual output sub-component (202) and speakers as the audio output sub-component (203).

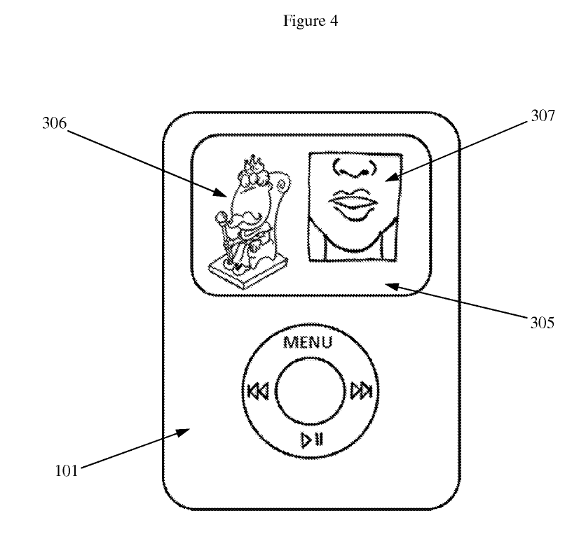

Referring to FIG. 4, the software application's graphical user interface (305) as seen on the display screen (102) of a digital device player (101). The user interface (305) also plays back a video (307) of a native speaker of the language pronouncing the word being learned by the user. The user interface (305) also displays a humorous picture (306) that is a visual description of the word being pronounced.

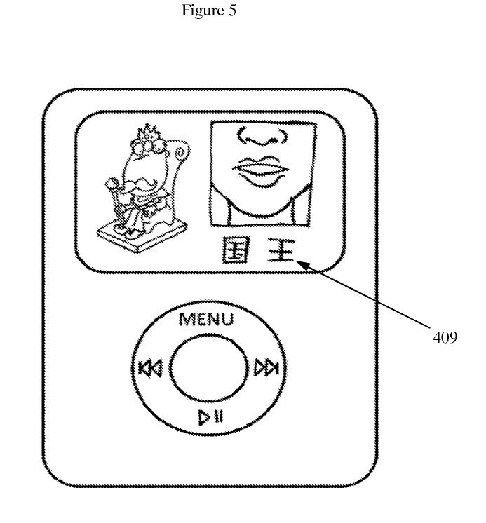

Referring to FIG. 5, the translation (409) of the word is shown in the user's native language, again here assumed to be Mandarin. This will aid the user to understand and completely comprehend what the word means in the user's own language.

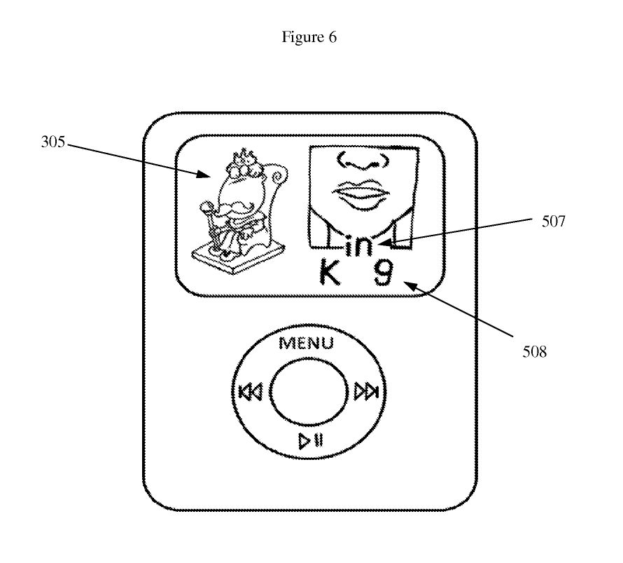

Referring to FIG. 6, the user interface (305) now includes an animated grapheme (507), (508) of the word (508) that needs to be pronounced in the target language (here assumed to be English). The grapheme shows the key syllable/s of the word as animated and colored text (507). The key syllables (507) being pronounced will generally be animated and colored differently to highlight its pronunciation.

An alternative version of the content, in addition to the information outlined in FIG. 6, also provides the spelling of the word in the target language. As the user watches the native speaker pronouncing the word and sees the picture, the key grapheme (507) that represents the sound being made (508) is animated and colored. The learner is still able to view the native speaker pronouncing the word in the target language, and to hear the correct pronunciation of the word in the target language.

Referring to FIG. 7, the invention's recommended composite sequence of operation is shown. However the invention is not limited to the arrangement and instrumentalities identified.

The preferred embodiment of the invention presented herein is a software application or series of multimedia files installed or downloaded onto a portable digital device. The first scenario (601) shows the software application played on the device player (101), and the user can hear audio output through the headset (audio output component) (103) and watch the video sequence through the screen (video output component) (102). The second scenario (602) shows the graphic user interface (305) and a display of a humorous picture (306) of the word being pronounced and a video clip (307) of the native speaker of that language. The third scenario (604) shows the translation (409) of the word in the native language of the user, here assumed to be Mandarin. The fourth scenario (603) is a display of the word (508) being pronounced in the target language (here English) and the animated grapheme of key syllables of the word to highlight pronunciation (507), (508).

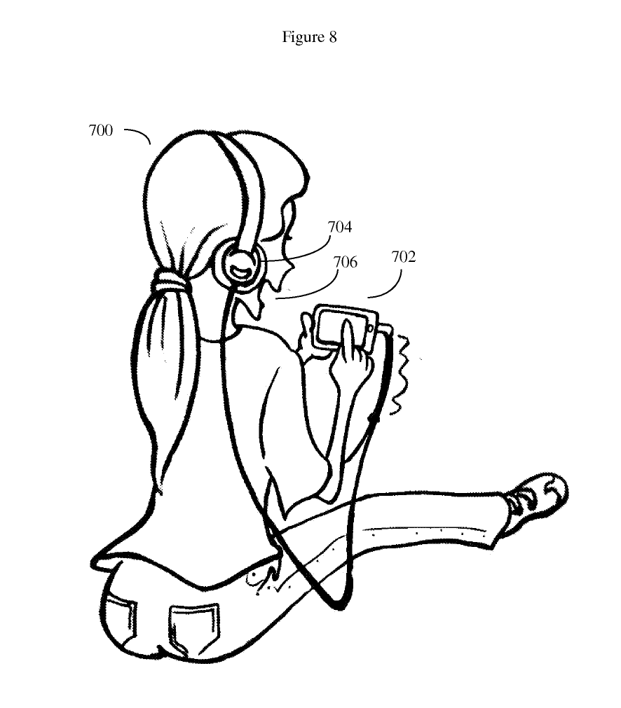

An example of the invention in operation is shown in FIG. 8. Here the user or learner (700) is watching a machine for playing back the content (702) (101), here using headphones to better hear the sound (704). The user is able to watch the native speaker (307) pronouncing a word and hear the accurate pronunciation of that word (706) at the same time. Additionally, a picture of the word being pronounced (306) is displayed to the learner. The picture helps the learner to grasp the meaning of the word in the target language very easily. This combination of audio and video material creates a rich sensory experience for the learner, which aids their memory. The learner can repeat each word aloud (706), being careful to mimic the shape of the native speaker's mouth and also to compare their own pronunciation with that of the native speaker.

In each video, a variety of commonly used words that include the particular sound are broadcast. This gives the learner (700) multiple opportunities to mimic the way the native speaker moves their lips and practice their own pronunciation.

As an example, we can consider a version of the invention for teaching the English language. There are over 100 episodes or lessons in this program. Each episode contains a different sound that is commonly used in the English language. For example, one of the lesson videos contains words that use the “ay” sound (e.g. late, eight, hay etc). Another lesson video would include words that use a short “a” sound (e.g. bat, hat, mat, cat etc). In addition to the vowel sounds, there are also videos that include words which have the “ng” sound in them (e.g. king, sing, wrong etc).

There are multiple versions of the lesson video in each episode. The version that includes the spelling in the target language contains the same words, video and pictures as the first video, plus the addition of the spelling of each word (508). Animating the key elements of the sound in the grapheme (507) helps the learner to master the spelling rules in the target language and to remember the meaning of the words.

An alternative version of the video replaces the spelling of each word in the target language with the translation of each word in the learner's native language (409). This combination of the picture (306) and the translation of the word into the learner's native language helps the learner to link the pronunciation of the word and its correct meaning.

The content is designed for delivery upon a mobile device that the learner can carry with them at anytime. Since the learner is able to practice at any time or in any place, they can improve their pronunciation more quickly than if they were only able to practice at specific times or in specific locations.

### Alternate Embodiments

In one embodiment, the invention simultaneously presents Native Speaker Audio sounds, Native Speaker Visual images or movies and Word Pictures to provide a complete “role model” for the learner to acquire correct pronunciation. The invention may do this by using humorous cartoons which act as a further memory trigger. The use of video has advantages, because it captures the entire range of the sound as opposed to a still image which can only capture a certain part. In one embodiment, the invention may select 1,300 high frequency words in order to connect the sound instruction to the vocabulary of words the learner is most likely to encounter in daily conversation. The inventions multimedia files or programs may be packaged within a mobile computerized device capable of audio-video playback in order to support anytime, anywhere learning

The invention may additionally present of the spelling of each word in order to connect the pronunciation of the sounds with their actual spelling. Here words are grouped around specific sounds to demonstrate to the learner how the language may use different graphemes to represent the same sound. As previously discussed, these graphemes may be animated, and color may also be used, particularly for the key grapheme section.

The invention may also make an additional presentation of the learner's native language in order to reinforce the meaning of the words that are introduced. The invention may also use different subtitle sets in order to make the system user-friendly to users of different languages, or to switch the language and produce a similar tool for learners of any foreign language. As previously discussed, often it will be useful to deliberately play the words along a specified rhythm, which tends to enhance memory retention. Additionally, the invention may display a space between each word (i.e. with enough time duration between words) so that the user may repeat the pronunciation of each word in order to evaluate the user's own efforts.

Thus the invention may also be viewed as a method of teaching a new language, ensuring correct pronunciation and spelling of words and a method of the same for other languages. This method being implemented on an interactive audio-visual multimedia application running on an audio-visual capable multimedia system. Here the method will display will the written form of the word in the language being taught, and may display the pronunciation of the word is displayed as colored text, e.g. a grapheme. The method and system may produce the sound and video of word/s in a rhythmic pattern, and the files or programs produced by this method can be uploaded, installed, programmed in any applicable manner onto digital mobile devices. The files produced by this method can be installed on a desktop computer or any other stationary computing device.

The system will often displays a video of a person speaking their native language, and this will be displayed on a system with a visual display unit such as, but is not limited to, a monitor or a screen. This system will generally also have an audio output device such as, but not limited to, a speaker or a headset. The method will group words around specific sounds or phonemes, and use colored graphemes to emphasize every syllable of the word being taught. The method and system may animate and display the key element of the grapheme (i.e. the particular sound that is being emphasized) in a different color to enhance memorization. The system will often also utilizes motion picture (as opposed to still frame) to capture the entire sound formation of the word, as opposed to a single, sound element. Additionally, the method and system may also produce a time gap between each word being taught. To enhance learning, the system will often also display a humorous cartoon or image with each displayed word to reinforce learning. Often similar sounding words will be grouped by the method so that the user can differentiate each pronunciation and the specific sound each word makes. The method will usually also teach the most frequently used words of the particular target language being taught.

This method may be used in a standard, classroom setting, by a single user, or alternatively be uploaded on the Internet and conveniently accessed by users anywhere.

1. A method of producing language instruction multimedia for instructing speakers of a first language on how to speak a target language, said method comprising;
Obtaining a list of the most frequently used words in a target language;
allocating individual words in said list to different sound groups;
defining lesson sized subgroups of words that each contain the same or similar sound group sound;
producing cartoon images portraying the meaning of each word in said lesson sized subgroups;
producing video and sound of a native speaker pronouncing each word in said lesson sized subgroups;
for each lesson sized subgroup, producing three separate multimedia lessons, wherein the first lesson comprises a multimedia video of the image of the word and the video and sound of the word, the second lesson comprises a multimedia video of the image of the word, the video and sound of the word, and the word presented in written form in the first language, and the third lesson comprises a multimedia of the image of the word, the video and sound of the word, and the word presented in written form in the target language; and
wherein said instruction media may be viewed on a video player; an audio video capable computerized device; a computer, or transmitted over the internet for viewing on a remote computerized device.

2. The method of claim 1, wherein said list of frequently used words in a target language is between 500 and 2000 words.

3. The method of claim 1, wherein the list of frequently used words in a target language is between 700 and 1300 words.

4. The method of claim 1, wherein the different sound groups comprises between 30 and 150 different sounds.

5. The method of claim 1, wherein the lesson sized subgroups is between 8 and 20 words.

6. The method of claim 1, wherein the video and sound of a native speaker pronouncing each word is a video and sound of the native speaker's face from the middle of the nose to the neck of the native speaker.

7. The method of claim 1, wherein the key sound of each word is highlighted in a different color when this word is shown in an instructional lesson.

8. The method of claim 1, wherein each successive word in a lesson occurs in a rhythmic pattern.

9. The method of claim 1, wherein the word presented in written form in either the first language or the target language is presented in colored or uncolored grapheme text form.

10. The method of claim 9, wherein said grapheme is animated during the lesson.

11. The method of claim 1, wherein all steps are automatically performed under the control of at least one program running on at least one computer processor.

12. A method of producing language instruction multimedia for instructing speakers of a first language on how to speak a target language, said method comprising;
Obtaining a list of the most frequently used words in a target language;
wherein said list of frequently used words in a target language is between 500 and 2000 words;
Allocating individual words in said list to different sound groups;
wherein the different sound groups comprises between 30 and 150 different sounds;
defining lesson sized subgroups of words that each contain the same or similar sound group sound;
wherein the lesson sized subgroups is between 8 and 20 words;
producing cartoon images portraying the meaning of each word in said lesson sized subgroups;
producing video and sound of a native speaker pronouncing each word in said lesson sized subgroups;
wherein the video and sound of a native speaker pronouncing each word is a video and sound of the native speaker's face from the middle of the nose to the neck of the native speaker;
for each lesson sized subgroup, producing three separate multimedia lessons, wherein the first lesson comprises a multimedia video of the image of the word and the video and sound of the word, the second lesson comprises a multimedia video of the image of the word, the video and sound of the word, and the word presented in written form in the first language, and the third lesson comprises a multimedia of the image of the word, the video and sound of the word, and the word presented in written form in the target language; and
wherein said instruction media may be viewed on a video player; an audio video capable computerized device; a computer, or transmitted over the internet for viewing on a remote computerized device.

13. The method of claim 13, wherein the key sound of each word is highlighted in a different color when this word is shown in an instructional lesson.

14. The method of claim 12, wherein each successive word in a lesson occurs in a rhythmic pattern.

15. The method of claim 12, wherein the word presented in written form in either the first language or the target language is presented in colored or uncolored grapheme text form.

16. The method of claim 15, wherein said grapheme is animated during the lesson.

17. A method of producing language instruction multimedia for instructing speakers of a first language on how to speak a target language, said method comprising;
Obtaining a list of the most frequently used words in a target language;
wherein said list of frequently used words in a target language is between 500 and 2000 words;
Allocating individual words in said list to different sound groups;
wherein the different sound groups comprises between 30 and 150 different sounds;
defining lesson sized subgroups of words that each contain the same or similar sound group sound;
wherein the lesson sized subgroups is between 8 and 20 words;
producing cartoon images portraying the meaning of each word in said lesson sized subgroups;
producing video and sound of a native speaker pronouncing each word in said lesson sized subgroups;
wherein the video and sound of a native speaker pronouncing each word is a video and sound of the native speaker's face from the middle of the nose to the neck of the native speaker;
for each lesson sized subgroup, producing three separate multimedia lessons, wherein the first lesson comprises a multimedia video of the image of the word and the video and sound of the word, the second lesson comprises a multimedia video of the image of the word, the video and sound of the word, and the word presented in written form in the first language, and the third lesson comprises a multimedia of the image of the word, the video and sound of the word, and the word presented in written form in the target language;
wherein the key sound of each word is highlighted in a different color when this word is shown in an instructional lesson;
wherein the word presented in written form in either the first language or the target language is presented in colored and animated grapheme text form;
wherein each successive word in a lesson occurs in a rhythmic pattern; and
wherein said instruction media may be viewed on a video player; an audio video capable computerized device; a computer, or transmitted over the internet for viewing on a remote computerized device.
